(19) United States
(12) Patent Application Publication
(10) Pub. No.: US 2021/0079263 A1
(43) Pub. Date: Mar. 18, 2021

(54) HIGH MOLECULAR WEIGHT POLYVINYL PYRROLIDONE FOR LOW-K REMOVAL RATE SUPPRESION

(71) Applicant: FUJIMI INCORPORATED, Kiyosu-shi (JP)

(72) Inventor: Jimmy Erik GRANSTROM, Tualatin, OR (US)

(73) Assignee: FUJIMI INCORPORATED, Kiyosu-shi (JP)

(21) Appl. No.: 16/987,632

(22) Filed: Aug. 7, 2020

Related U.S. Application Data
(60) Provisional application No. 62/901,506, filed on Sep. 17, 2019.

(51) Int. Cl. C09G 1/02; B24B 37/04

(52) U.S. Cl. CPC C09G 1/02; B24B 37/044

(57) ABSTRACT

Provided herein are compositions and methods for polishing surfaces comprising one or more low-k materials and optionally one or more additional materials (e.g., Cu, Ta, Co, Ni, etc.), e.g., in semiconductor device fabrication. Embodiments include a composition for chemical mechanical polishing of a surface comprising a low-k material (e.g., Black Diamond (BD)) the composition comprising an abrasive, a solvent, and a polymeric low-k suppressor.

### TECHNICAL FIELD

The present invention relates generally to the field of compositions and methods for polishing surfaces comprising one or more low-k materials.

### BACKGROUND

A major challenge in the field of chemical mechanical polishing (“CMP”) for semiconductor manufacturing is selective polishing. Low-k materials, such as Black Diamond™ (BD, low-k, SiOCH) are commonly used in interlayer dielectrics (“ILDs”) of semiconductor devices. However, current CMP compositions for removing additional materials (e.g., non-low-k materials such as Ni, Cu, Ta, Co, etc.) suffer from also having high removal rates for low-k materials, such as those used in ILDs.

Accordingly, there exists a need for novel CMP compositions that can suppress the removal rate for low-k materials (e.g., BD) while permitting efficient and effective removal of additional materials (e.g., non-low-k materials such as metals).

### SUMMARY OF THE INVENTION

Provided herein are compositions and methods for polishing surfaces comprising one or more low-k materials, e.g., in semiconductor device fabrication.

### BRIEF DESCRIPTION OF THE DRAWINGS

FIG. 1 shows black diamond (BD) removal rate versus PVP grade (K-15, K-30, K-60, K-90, K-120) and concentration. A PVP grade with a higher weight average molecular weight (e.g. K-90 or K-120) enables a lower BD removal rate than a PVP grade with a lower weight average molecular weight (e.g. K-15 or K-30), at concentrations ≤0.14 wt-%. A smaller difference in BD removal rates is observed at 0.7 wt-%, indicating that the benefit of using a higher M_{w} PVP grade is most pronounced at a lower PVP concentration.

FIG. 2 shows BD removal rate vs. PVP weight average molecular weight (M_{w}) and amount. A higher weight average molecular weight generally enables a lower BD removal rate, but the effect is most pronounced for PVP concentrations ≤0.14 wt-%.

FIG. 3 shows BD removal rates versus M_{w}×C², where M_{w} is PVP weight average molecular weight, expressed in kg/mol, and C is PVP concentration, expressed as g/kg. A good logarithmic fit is observed between BD removal rates and M_{w}×C², indicating that M_{w}×C²≥2.65 mg/mol enables BD removal rates ≤276 Å/min.

FIG. 4A is a schematic illustration of polymer chain configuration on a surface. FIG. 4B illustrates overlap concentration of polymer coils, where c is the actual concentration and c* is the overlap concentration. c>c* results in polymer coil overlap and a semi-dilute polymer solution.

### DETAILED DESCRIPTION

As used herein, the terms “chemical mechanical polishing,” “CMP,” or “planarization” refers to a process of planarizing (polishing) a surface with the combination of surface chemical reaction and mechanical abrasion. In some embodiments, the chemical reaction is initiated by applying to the surface a composition (interchangeably referred to as a “CMP composition,” a “CMP slurry,” a “polishing slurry,” a “polishing composition,” a “slurry composition,” or simply a “slurry”) capable of reacting with a surface material, thereby turning the surface material into a product that can be more easily removed by simultaneous mechanical abrasion. In some embodiments, the mechanical abrasion is performed by contacting a polishing pad with the surface, and moving the polishing pad relative to the surface.

As used herein, the term “low-k material” is used as it is commonly understood in the art. Low-k material or “low-κ material” is a material with a small dielectric constant relative to silicon dioxide. Examples of low-k materials include, but are not limited to, SiOCH, SiOC, and carbon-doped oxides, such as Black Diamond™ (Applied Materials), Black Diamond™ 2 (Applied Materials), Black Diamond™ 3 (Applied Materials), Aurora™ 2.7 (ASM International N.V.), and Aurora™ ULK (ASM International N.V.), etc.

The CMP compositions disclosed herein can comprise, consist essentially of, or consist of one or more of the following components.

Abrasive

The CMP compositions of the present disclosure comprise at least one abrasive. The abrasive in the CMP composition provides or enhances mechanical abrasion effects during the CMP process. Examples of abrasives that can be used in connection with the present disclosure include but are not limited to alumina abrasives, silica abrasives, ceria abrasives, titanium oxide, zirconia, or mixtures thereof, preferably alumina, ceria, and silica; and more preferably silica.

In some embodiments, the mean particle size of the abrasive is preferably controlled to reduce scratch defects. The average primary particle diameter of the abrasive grains may be calculated, for example, based on a specific surface area of the abrasive grains, which is measured by a BET method. In some embodiments, the lower limit of an average primary particle diameter of the abrasive grains is 5 nm or more, 7 nm or more, or 10 nm or more. Furthermore, the upper limit of the average primary particle diameter of the abrasive grains is 300 nm or less, 200 nm or less, 100 nm or less. In some embodiments, the average primary particle diameter of the abrasive grains is between about 5 nm and about 300 nm, between about 7 nm and about 200 nm, or between about 10 nm and about 100 nm, or any range or value therein. In some embodiments, the average primary particle diameter is about 5 nm, about 6 nm, about 7 nm, about 8 nm, about 9 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, or about 300 nm, or any value thereinbetween. Within such a range, the polishing rate of the polishing object by the polishing composition is improved, and it is possible to further suppress an occurrence of polishing defects (scratches) on the surface of the polishing object after the polishing object is polished by using the polishing composition.

The average secondary particle diameter value of the abrasive grains can be determined by, for example, the laser light scattering method. In some embodiments, the upper limit of an average secondary particle diameter of the abrasive grains is 500 nm or less, 400 nm or less, 300 nm or less, or 250 nm or less. The lower limit of the average secondary particle diameter of the abrasive grains is 10 nm or more, 15 nm or more, or 20 nm or more. In some embodiments, the average secondary particle diameter of the abrasive grains is between about 10 nm and about 500 nm, between about 15 nm and about 400 nm, between about 20 nm and about 300 nm, or between about 20 nm and about 250 nm, or any range or value therein. In some embodiments, the average secondary particle diameter of the abrasive grains is about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 350 nm, about 400 nm, about 450 nm, or about 500 nm, or any value thereinbetween.

In some embodiments, the present CMP composition comprises at least about 0.01% to about 20% by weight of the abrasive. In some embodiments, the amount of the abrasive in the present CMP composition is no greater than about 20% by weight, no greater than about 19% by weight, no greater than about 18% by weight, no greater than about 17% by weight, no greater than about 16% by weight, no greater than about 15% by weight, no greater than about 14% by weight, no greater than about 13% by weight, no greater than about 12% by weight, no greater than about 11% by weight, no greater than about 10% by weight, no greater than about 9% by weight, no greater than about 8% by weight, no greater than about 7% by weight, no greater than about 6% by weight, no greater than about 5% by weight, no greater than about 4% by weight, no greater than about 3% by weight, no greater than about 2% by weight, no greater than about 1% by weight, no greater than about 0.9% by weight, no greater than about 0.8% by weight, no greater than about 0.7% by weight, no greater than about 0.6% by weight, no greater than about 0.5% by weight, no greater than about 0.4% by weight, no greater than about 0.3% by weight, no greater than about 0.2% by weight, or no greater than about 0.1% by weight (or ranges thereinbetween).

In some embodiments the CMP composition comprises an abrasive in a concentration of at least about 0.1% by weight, at least about 0.2% by weight, at least about 0.3% by weight, at least about 0.4% by weight, at least about 0.5% by weight, at least about 0.6% by weight, at least about 0.7% by weight, at least about 0.8% by weight, at least about 0.9% by weight, at least about 1.0% by weight, at least about 2% by weight, at least about 3% by weight, at least about 4% by weight, at least about 5% by weight, at least about 6% by weight, at least about 7% by weight, at least about 8% by weight, at least about 9% by weight, at least about 10% by weight, at least about 11% by weight, at least about 12% by weight, at least about 13% by weight, at least about 14% by weight, at least about 15% by weight, at least about 16% by weight, at least about 17% by weight, at least about 18% by weight, at least about 19% by weight, or at least about 20% by weight (or ranges thereinbetween).

Solvent

In some embodiments, the CMP compositions disclosed herein comprise one or more solvents. The solvent of the CMP slurry is not particularly limited. In some embodiments, the solvent is water, such as deionized water, a protic or nonprotic organic solvent such as an alcohol (e.g., methanol, ethanol, or isopropanol), or a mixture of two or more thereof.

Polymeric Low-k Suppressor

In some embodiments, the CMP compositions disclosed herein comprise one or more polymeric low-k suppressors. In some embodiments, the low-k compressor may be selected from polyvinyl pyrrolidone (PVP), aliphatic polyketones, poly (vinyl methyl ketone), poly (N-hydroxy propyl)methacrylamide, poly (N-vinyl acetamide), polylactic acid (PLA), poly(N-butyl methacrylate), poly(N-vinylpyrrolidone/vinyl acetate) and poly(ethylene oxide).

In some embodiments, the one or more polymeric low-k suppressors may contain one or more carbonyl groups and optionally one or more ethoxylated units. Examples include, but are not limited to, PVP, aliphatic polyketones, poly (vinyl methyl ketone), poly (N-hyroxypropyl)methacrylamide, poly (N-vinyl acetamide), polylactic acid (PLA), poly (N-butyl methacrylate), and poly (N-vinylpyrrolidone/vinyl acetate), or combinations thereof. In some embodiments, the CMP composition may include one or more polymeric low-k suppressors that do not contain a carbonyl group, including, for example, poly(ethylene oxide).

In some embodiments, the polymeric low-k suppressor is PVP of the following formula (I):

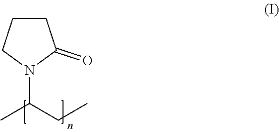

In some embodiments, the polymeric low-k suppressor has a weight average molecular weight (M_{w}) of at least about 4 kg/mol, at least about 4.5 kg/mol, at least about 5 kg/mol, at least about 5.5 kg/mol, at least about 6 kg/mol, at least about 6.5 kg/mol, at least about 7 kg/mol, at least about 7.5 kg/mol, at least about 8 kg/mol, at least about 8.5 kg/mol, at least about 9 kg/mol, at least about 9.5 kg/mol, at least about 10 kg/mol, at least about 15 kg/mol, at least about 20 kg/mol, at least about 25 kg/mol, at least about 30 kg/mol, at least about 35 kg/mol, at least about 40 kg/mol, at least about 45 kg/mol, at least about 50 kg/mol, at least about 55 kg/mol, at least about 60 kg/mol, at least about 65 kg/mol, at least about 70 kg/mol, at least about 75 kg/mol, at least about 80 kg/mol, at least about 85 kg/mol, at least about 90 kg/mol, at least about 95 kg/mol, at least about 100 kg/mol, at least about 150 kg/mol, at least about 200 kg/mol, at least about 250 kg/mol, at least about 300 kg/mol, at least about 350 kg/mol, at least about 390 kg/mol, at least about 400 kg/mol, at least about 450 kg/mol, at least about 500 kg/mol, at least about 550 kg/mol, at least about 600 kg/mol, at least about 650 kg/mol, at least about 700 kg/mol, at least about 750 kg/mol, at least about 800 kg/mol, at least about 850 kg/mol, at least about 900 kg/mol, at least about 950 kg/mol, at least about 1,000 kg/mol, at least about 1,500 kg/mol, at least about 2,000 kg/mol, at least about 2,500 kg/mol, or at least about 3,000 kg/mol (or ranges thereinbetween).

In some embodiments, the polymeric low-k suppressor has a weight average molecular weight (M) of no greater than about 3,000 kg/mol, no greater than about 2,500 kg/mol, no greater than about 2,000 kg/mol, no greater than about 1,500 kg/mol, no greater than about 1,000 kg/mol, no greater than about 950 kg/mol, no greater than about 900 kg/mol, no greater than about 850 kg/mol, no greater than about 800 kg/mol, no greater than about 750 kg/mol, no greater than about 700 kg/mol, no greater than about 650 kg/mol, no greater than about 600 kg/mol, no greater than about 550 kg/mol, no greater than about 500 kg/mol, no greater than about 450 kg/mol, no greater than about 400 kg/mol, no greater than about 390 kg/mol, no greater than about 350 kg/mol, no greater than about 300 kg/mol, no greater than about 250 kg/mol, no greater than about 200 kg/mol, no greater than about 150 kg/mol, no greater than about 100 kg/mol, no greater than about 95 kg/mol, no greater than about 90 kg/mol, no greater than about 85 kg/mol, no greater than about 80 kg/mol, no greater than about 75 kg/mol, no greater than about 70 kg/mol, no greater than about 65 kg/mol, no greater than about 60 kg/mol, no greater than about 55 kg/mol, no greater than about 50 kg/mol, no greater than about 45 kg/mol, no greater than about 40 kg/mol, no greater than about 35 kg/mol, no greater than about 30 kg/mol, no greater than about 25 kg/mol, no greater than about 20 kg/mol, no greater than about 15 kg/mol, no greater than about 10 kg/mol, no greater than about 9.5 kg/mol, no greater than about 9 kg/mol, no greater than about 8.5 kg/mol, no greater than about 8 kg/mol, no greater than about 7.5 kg/mol, no greater than about 7 kg/mol, no greater than about 6.5 kg/mol, no greater than about 6 kg/mol, no greater than about 5.5 kg/mol, no greater than about 5 kg/mol, no greater than about 4.5 kg/mol, or no greater than about 4 kg/mol (or ranges thereinbetween).

In some embodiments, the polymeric low-k suppressor has a weight average molecular weight (M) between about 4 kg/mol and about 4.5 kg/mol, between about 4.5 kg/mol and about 5 kg/mol, between about 5 kg/mol and about 5.5 kg/mol, between about 5.5 kg/mol and about 6 kg/mol, between about 6 kg/mol and about 6.5 kg/mol, between about 6.5 kg/mol and 7 kg/mol, between about 7 kg/mol and about 7.5 kg/mol, between about 8 kg/mol and about 8.5 kg/mol, between about 8.5 kg/mol and about 9 kg/mol, between about 9 kg/mol and about 9.5 kg/mol, between about 9.5 kg/mol and about 10 kg/mol, between about 10 kg/mol and about 15 kg/mol, between about 15 kg/mol and about 20 kg/mol, between about 20 kg/mol and about 25 kg/mol, between about 25 kg/mol and about 30 kg/mol, between about 30 kg/mol and about 35 kg/mol, between about 35 kg/mol and about 40 kg/mol, between about 40 kg/mol and about 45 kg/mol, between about 45 kg/mol and about 50 kg/mol, between about 50 kg/mol and about 55 kg/mol, between about 55 kg/mol and about 60 kg/mol, between about 60 kg/mol and about 65 kg/mol, between about 65 kg/mol and about 70 kg/mol, between about 70 kg/mol and about 75 kg/mol, between about 75 kg/mol and about 80 kg/mol, between about 80 kg/mol and about 85 kg/mol, between about 85 kg/mol and about 90 kg/mol, between about 90 kg/mol and about 95 kg/mol, between about 95 kg/mol and about 100 kg/mol, between about 100 kg/mol and about 150 kg/mol, between about 150 kg/mol and about 200 kg/mol, between about 200 kg/mol and about 250 kg/mol, between about 250 kg/mol and about 300 kg/mol, between about 300 kg/mol and about 350 kg/mol, between about 350 kg/mol and about 400 kg/mol, between about 400 kg/mol and about 450 kg/mol, between about 450 kg/mol and about 500 kg/mol, between about 500 kg/mol and about 550 kg/mol, between about 550 kg/mol and about 600 kg/mol, between about 600 kg/mol and about 650 kg/mol, between about 650 kg/mol and about 700 kg/mol, between about 700 kg/mol and about 750 kg/mol, between about 750 kg/mol and about 800 kg/mol, between about 800 kg/mol and about 850 kg/mol, between about 850 kg/mol and about 900 kg/mol, between about 900 kg/mol and about 950 kg/mol, between about 950 kg/mol and about 1,000 kg/mol, between about 1,000 kg/mol and about 1,500 kg/mol, between about 1,500 kg/mol and about 2,000 kg/mol, between about 2,000 kg/mol and about 2,500 kg/mol, or between about 2,500 kg/mol and about 3,000 kg/mol (or ranges thereinbetween).

In some embodiments, the CMP composition has a concentration (wt-%) of the polymeric low-k suppressor of at least about 0.01 wt-%, at least about 0.02 wt-%, at least about 0.03 wt-%, at least about 0.04 wt-%, at least about 0.05 wt-%, at least about 0.06 wt-%, at least about 0.07 wt-%, at least about 0.08 wt-%, at least about 0.09 wt-%, at least about 0.10 wt-%, at least about 0.11 wt-%, at least about 0.12 wt-%, at least about 0.13 wt-%, at least about 0.14 wt-%, at least about 0.15 wt-%, at least about 0.16 wt-%, at least about 0.17 wt-%, at least about 0.18 wt-%, at least about 0.19 wt-%, at least about 0.20 wt-%, at least about 0.21 wt-%, at least about 0.22 wt-%, at least about 0.23 wt-%, at least about 0.24 wt-%, at least about 0.25 wt-%, at least about 0.26 wt-%, at least about 0.27 wt-%, at least about 0.28 wt-%, at least about 0.29 wt-%, at least about 0.30 wt-%, at least about 0.35 wt-%, at least about 0.40 wt-%, at least about 0.45 wt-%, at least about 0.50 wt-%, at least about 0.55 wt-%, at least about 0.60 wt-%, at least about 0.65 wt-%, at least about 0.70 wt-%, at least about 0.75 wt-%, at least about 0.80 wt-%, at least about 0.85 wt-%, at least about 0.90 wt-%, at least about 0.95 wt-%, at least about 1.0 wt-%, at least about 1.5 wt-%, at least about 2.0 wt-%, at least about 2.5 wt-%, at least about 3.0 wt-%, at least about 3.5 wt-%, at least about 4.0 wt-%, at least about 4.5 wt-%, at least about 5.0 wt-%, at least about 5.5 wt-%, at least about 6.0 wt-%, at least about 6.5 wt-%, at least about 7.0 wt-%, at least about 7.5 wt-%, at least about 8.0 wt-%, at least about 8.5 wt-%, at least about 9.0 wt-%, at least about 9.5 wt-%, at least about 10.0 wt-%, at least about 15.0 wt-%, at least about 20.0 wt-%, at least about 25.0 wt-%, at least about 30.0 wt-%, at least about 35.0 wt-%, at least about 40.0 wt-%, at least about 45.0 wt-%, or at least about 50.0 wt-% (or ranges thereinbetween).

In some embodiments of the CMP composition, the adsorption isotherm of the polymeric low-k suppressor onto a surface (e.g., a low-k material surface) is related to a quantity M_{w}×C², where M_{w} is the polymer weight average molecular weight (in kg/mol) and C is the polymer concentration (g/kg). In some embodiments, M_{w}×C² is greater than about 0.50 mg/mol, greater than about 0.55 mg/mol, greater than about 0.60 mg/mol, greater than about 0.65 mg/mol, greater than about 0.70 mg/mol, greater than about 0.75 mg/mol, greater than about 0.80 mg/mol, greater than about 0.85 mg/mol, greater than about 0.90 mg/mol, greater than about 0.95 mg/mol, greater than about 1.0 mg/mol, greater than about 1.5 mg/mol, greater than about 2.0 mg/mol, greater than about 2.5 mg/mol, greater than about 3.0 mg/mol, greater than about 3.5 mg/mol, greater than about 4.0 mg/mol, greater than about 4.5 mg/mol, greater than about 5.0 mg/mol, greater than about 5.5 mg/mol, greater than about 6.0 mg/mol, greater than about 6.5 mg/mol, greater than about 7.0 mg/mol, greater than about 7.5 mg/mol, greater than about 8.0 mg/mol, greater than about 8.5 mg/mol, greater than about 9.0 mg/mol, greater than about 9.5 mg/mol, greater than about 10.0 mg/mol, greater than about 15.0 mg/mol, greater than about 20.0 mg/mol, greater than about 25.0 mg/mol, greater than about 30.0 mg/mol, greater than about 35.0 mg/mol, greater than about 40.0 mg/mol, greater than about 45.0 mg/mol, greater than about 50.0 mg/mol, greater than about 55.0 mg/mol, greater than about 60.0 mg/mol, greater than about 65.0 mg/mol, greater than about 70.0 mg/mol, greater than about 75.0 mg/mol, greater than about 80.0 mg/mol, greater than about 85.0 mg/mol, greater than about 90.0 mg/mol, greater than about 95.0 mg/mol, greater than about 100.0 mg/mol, greater than about 150.0 mg/mol, or greater than about 200.0 mg/mol (or ranges thereinbetween).

pH

In some embodiments, although not particularly limited, the CMP composition has a pH between about 7.0 and about 14.0, inclusive of the end points, between about 7.5 and about 13.5, inclusive of the end points, between about 8.0 and about 13.0, inclusive of the end points, between about 8.5 and about 12.5, inclusive of the end points, between about 9.0 and about 12.0, inclusive of the end points, between about 9.5 and about 11.5, inclusive of the end points, or between about 10.0 and about 11.0, inclusive of the end points.

In some embodiments the CMP composition has a pH of about 9.0, about 9.1, about 9.2, about 9.3, about 9.4, about 9.5, about 9.6, about 9.7, about 9.8, about 9.9, about 10.0, about 10.1, about 10.2, about 10.3, about 10.4, about 10.5, about 10.6, about 10.7, about 10.8, about 10.9, about 11.0, about 11.1, about 11.2, about 11.3, about 11.4, about 11.5, about 11.6, about 11.7, about 11.8, about 11.9, or about 12.0 (or ranges or values thereinbetween).

In some embodiments, the CMP composition has a pH of at least about 10.0, at least about 10.5, at least about 11.0, at least about 11.5, at least about 12.0, at least about 12.5, at least about 13.0, or at least about 13.5 (or ranges thereinbetween). In some embodiments, the CMP composition has a pH of no greater than about 14.0, no greater than about 13.5, no greater than about 13.0, no greater than about 12.5, no greater than about 12.0, no greater than about 11.5, no greater than about 11.0, no greater than about 10.5, no greater than about 10.0, no greater than about 9.5, no greater than about 9.0, no greater than about 8.5, no greater than about 8.0, no greater than about 7.5, or no greater than about 7.0 (or ranges or values thereinbetween).

pH Adjusting Agent

In some embodiments, the CMP composition may further comprise a pH adjusting agent. In some embodiments, an acid or an alkali is used as the pH adjusting agent. The acid or alkali used in connection with the present invention can be organic or inorganic compounds. Examples of the acid include inorganic acids such as sulfuric acid, nitric acid, boric acid, carbonic acid, hypophosphorous acid, phosphorous acid, and phosphoric acid; and organic acids such as carboxylic acids including formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, and lactic acid, and organic sulfuric acids including methanesulfonic acid, ethanesulfonic acid, and isethionic acid. Examples of the alkali include hydroxides of an alkali metal, such as potassium hydroxide; ammonium hydroxide, ethylene diamine, and piperazine; and quaternary ammonium salts such as tetramethyl ammonium hydroxide and tetraethyl ammonium hydroxide. These acids or alkalis can be used either singly or in combination of two or more types.

Content of the acid or alkali in the CMP composition is not particularly limited as long as it is an amount allowing the CMP composition to be within the aforementioned pH ranges.

Other Components

The CMP composition of the present invention may contain, if necessary, other components, such as a preservative, a biocide, a reducing agent, a polymer, a surfactant, or the like.

In some embodiments, for the purpose of enhancing the hydrophilicity of the surface to be polished or increasing the dispersion stability of abrasive, a water-soluble polymer may be added to the present CMP composition. Examples of the water soluble polymer include a cellulose derivative such as hydroxymethyl cellulose, hydroxyethyl cellulose (HEC), hydroxypropyl cellulose, hydroxyethylmethyl cellulose, hydroxypropylmethyl cellulose, methyl cellulose, ethyl cellulose, ethylhydroxyethyl cellulose, or carboxymethyl cellulose; an imine derivative such as poly(N-acylalkyleneimine); polyvinyl alcohol; modified (cation-modified or non-ion modified) polyvinyl alcohol; polyvinyl pyrrolidone; polyvinylcaprolactam; polyoxyalkylene such as polyoxyethylene; and a copolymer containing those constitutional units. The water-soluble polymer may be used either alone or as a mixture of two or more kinds.

In some embodiments, the CMP composition according to the present disclosure may also comprise a biocide or other preservatives. Examples of preservatives and biocides that may be used in connection with the present invention include an isothiazoline-based preservative such as 2-methyl-4-isothiazolin-3-one or 5-chloro-2-methyl-4-isothiazolin-3-one, paraoxybenzoate esters, and phenoxyethanol, and the like. These preservatives and biocides may be used either alone or in mixture of two or more kinds thereof.

In some embodiments, the CMP composition according to the present disclosure may also comprise a corrosion inhibitor. The corrosion inhibitor may be any compound that on one hand effectively suppresses, e.g., metal and/or silicate corrosion under the CMP conditions, and on the other hand also permits, e.g., a high metal and/or silicate removal rate.

In some embodiments, the present CMP composition comprises one or more azole compounds including, but not limited to, benzotriazoles, benzimidazoles, triazoles, imidazole, tolyltriazole, and any combination thereof. Specific examples include, but are not limited to, benzotriazole, 1-(1,2-dicarboxyethyl)benzotriazole, 1-[N,N-bis(hydroxyethyl)aminomethyl]benzotriazole, 1-(2,3-dihyroxypropyl)benzotriazole, and 1-(hydroxymethyl)benzotriazole. In some embodiments, the present CMP composition the metal and/or silicate corrosion inhibitor consists of one or more of the above compounds.

Methods and Compositions

In another aspect of the present disclosure, provided herein are methods for chemical mechanical polishing (CMP) of an object having at least one surface. The method comprises contacting the surface with a polishing pad; delivering a CMP composition according to the present disclosure to the surface; and polishing said surface with the CMP composition. In some embodiments, the surface includes one or more low-k materials and optionally one additional material (e.g., a material that is not a low-k material).

In another aspect of the present disclosure, provided herein are methods for suppressing the removal of one or more low-k materials during a chemical mechanical polishing (CMP) process. The method comprises using the CMP composition according to the present disclosure.

In another aspect of the present disclosure, provided herein are systems for chemical mechanical polishing (CMP). The system comprises a substrate comprising at least one surface having one or more low-k materials and optionally one or more additional materials, a polishing pad, and a CMP composition according to the present disclosure.

In yet another aspect of the present disclosure, provided herein is a substrate comprising at least one surface comprising one or more low-k materials and optionally one or more additional materials, wherein the substrate is in contact with a chemical mechanical polishing (CMP) composition according to the present disclosure.

In some embodiments, the present methods and compositions are suitable for polishing a low-k material surface. An apparatus or conditions commonly used for low-k material polishing can be adopted and modified according to particular needs. The selections of a suitable apparatus and/or conditions for carrying out the present methods are within the knowledge of a skilled artisan.

Low-k Removal Rate

In some embodiments, the present CMP compositions and methods enable reduced removal rates for low-k materials. Reduced removal rates for low-k materials are advantageous where removing one material (e.g., a metal such as Cu, Ni, Co, or Ta) at a higher rate is preferred, while leaving one or more low-k materials relatively intact or removing one or more low-k materials at a relatively slower rate. Thus, in some applications, the present CMP compositions selectively remove one or more additional materials (e.g., Cu, Ta, Ni, etc.) at a higher rate than one or more low-k materials.

In some embodiments, the present CMP compositions enable reduced low-k material removal rates. In some embodiments, the low-k removal rate is no greater than about 200 Å/min, no greater than about 205 Å/min, no greater than about 210 Å/min, no greater than about 215 Å/min, no greater than about 220 Å/min, no greater than about 225 Å/min, no greater than about 230 Å/min, no greater than about 235 Å/min, no greater than about 240 Å/min, no greater than about 245 Å/min, no greater than about 250 Å/min, no greater than about 255 Å/min, no greater than about 260 Å/min, no greater than about 265 Å/min, no greater than about 270 Å/min, no greater than about 275 Å/min, no greater than about 280 Å/min, no greater than about 285 Å/min, no greater than about 290 Å/min, no greater than about 295 Å/min, no greater than about 300 Å/min, no greater than about 350 Å/min, no greater than about 400 Å/min, no greater than about 450 Å/min, no greater than about 500 Å/min, no greater than about 550 Å/min, no greater than about 600 Å/min, no greater than about 650 Å/min, no greater than about 700 Å/min, no greater than about 750 Å/min, no greater than about 800 Å/min, no greater than about 850 Å/min, no greater than about 900 Å/min, no greater than about 950 Å/min, or no greater than about 1,000 Å/min (or any range or value thereinbetween).

In some embodiments of the CMP composition, the low-k removal rate is at least about 200 Å/min, at least about 205 Å/min, at least about 210 Å/min, at least about 215 Å/min, at least about 220 Å/min, at least about 225 Å/min, at least about 230 Å/min, at least about 235 Å/min, at least about 240 Å/min, at least about 245 Å/min, at least about 250 Å/min, at least about 255 Å/min, at least about 260 Å/min, at least about 265 Å/min, at least about 270 Å/min, at least about 275 Å/min, at least about 280 Å/min, at least about 285 Å/min, at least about 290 Å/min, at least about 295 Å/min, at least about 300 Å/min, at least about 350 Å/min, at least about 400 Å/min, at least about 450 Å/min, at least about 500 Å/min, at least about 550 Å/min, at least about 600 Å/min, at least about 650 Å/min, at least about 700 Å/min, at least about 750 Å/min, at least about 800 Å/min, at least about 850 Å/min, at least about 900 Å/min, at least about 950 Å/min, or at least about 1,000 Å/min (or ranges therein between).

In some embodiments, the present methods result in a removal rate for an additional material (e.g., a non-low-k material) of greater than 100 Å/min, e.g., about 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, or 4000 Å/min (or any value or range thereinbetween).

In some embodiments, the present methods result in a selectivity (e.g., SiO₂ removal rate to low-k material removal rate) of greater than about 10, e.g., greater than about 20, greater than about 30, greater than about 40, greater than about 50, greater than about 60, greater than about 70, greater than about 80, greater than about 90, greater than about 100, greater than about 200, greater than about 300, greater than about 400, greater than about 500, greater than about 600, greater than about 700, greater than about 800, greater than about 900, greater than about 1000, greater than about 1100, greater than about 1200, greater than about 1300, greater than about 1400, greater than about 1500, greater than about 1600, greater than about 1700, greater than about 1800, greater than about 1900, greater than about 2000, greater than about 2100, greater than about 2200, greater than about 2300, greater than about 2400, greater than about 2500, greater than about 2600, greater than about 2700, greater than about 2800, greater than about 2900, greater than about 3000, greater than about 3100, greater than about 3200, greater than about 3300, greater than about 3400, greater than about 3500, greater than about 3600, greater than about 3700, greater than about 3800, greater than about 3900, or greater than about 4000 (or any range or value thereinbetween).

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely”, “only” and the like in connection with the recitation of claim elements, or use of a “negative” limitation.

The term “about” will be understood by persons of ordinary skill in the art and will vary to some extent depending upon the context in which it is used. If there are uses of the term which are not clear to persons of ordinary skill in the art given the context in which it is used, “about” will mean up to plus or minus 10% of the particular term. Certain ranges are presented herein with numerical values being preceded by the term “about”. The term “about” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

This disclosure is not limited to particular embodiments described, as such may, of course, vary. It is also to be understood that the terminology used herein is for the purpose of describing particular embodiments only, and is not intended to be limiting, since the scope of the present invention will be limited only by the appended claims.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order that is logically possible.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates that may need to be independently confirmed.

The following examples are given for the purpose of illustrating various embodiments of the disclosure and are not meant to limit the present disclosure in any fashion. One skilled in the art will appreciate readily that the present disclosure is well adapted to carry out the objects and obtain the ends and advantages mentioned, as well as those objects, ends and advantages inherent herein. The present examples, along with the methods described herein are presently representative of embodiments and are exemplary, and are not intended as limitations on the scope of the disclosure. Changes therein and other uses which are encompassed within the spirit of the disclosure as defined by the scope of the claims will occur to those skilled in the art.

### EXAMPLES

### Example 1: CMP Polishing Compositions

CMP compositions according to the present disclosure were prepared by adding different amounts and grades of PVP to the slurry formulation shown in Table 1. Formulations were prepared by adding 0.07 wt-%, 0.14 wt-%, or 0.70 wt-% of PVP (K-15, K-30, K-60, K-90, or K-120). All the slurries contained the same ingredients and amounts shown in Table 1, except for different PVP grades and amounts indicated in Table 1.

TABLE 1
CMP Polishing Compositions

| Component | Amount (wt-%) |
|---|---|
| Colloidal Silica | 16.15 |
| primary particle diameter: 35 nm; | (solids content) |
| secondary particle diameter: 68 nm | |
| Citric Acid | 0.72 |
| Potassium Hydroxide (45%) | 4.41 |
| benzotriazole | 0.08 |
| Polyvinylpyrrolidone (PVP) | 0.07, 0.14, or 0.70 |
| (K-15, K-30, K-60, K-90, or K-120) | |
| KATHON ™ CG/ICP II (Biocide) | 0.04 |
| DI water | Remainder |
| Total | 100.00 |
| pH | 10.5 |

### Example 2: Polishing Apparatus and Polishing Conditions

The following conditions were used for all polishing experiments described herein:
Polishing apparatus: Model 372M Wafer Polisher by Westech
Polishing pad: H7000 by Fujibo
Polishing pressure: 2.0 psi (1 psi=6894.76 Pa, the same applies hereinafter)
Rotation number of polishing table: 117 rpm
Supply of polishing composition: constant flowing
Supply amount of polishing composition: 200 mL/min
Polishing time: 30 seconds.

Polishing rates were determined by comparing film thicknesses (t) before and after the polishing step described above. Film thicknesses were obtained by the optical interference film thickness measurement system (F50 thin-film mapper; Filmetrics). A polishing rate (removal rate; “RR”) was calculated from film thickness (t) according to the following equation:

$$Polishing Rate ( \frac{Å}{min} ) = \frac{{t}_{before polishing} ( Å ) - {t}_{after polishing } ( Å )}{time ( min )}$$

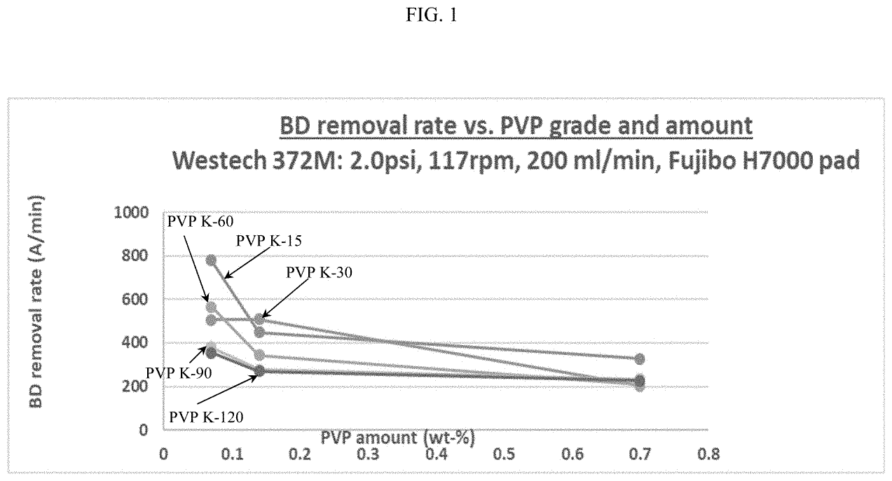

FIG. 1 and Table 2 show low-k black diamond (BD) removal rates versus PVP grade (K-15, K-30, K-60, K-90, K-120) and concentration. FIG. 1 shows that a PVP grade with a higher weight average molecular weight (e.g. K-90 or K-120) enables a lower BD removal rate than a PVP grade with a lower weight average molecular weight (e.g., K-15 or K-30), at concentrations ≤0.14 wt-%. A smaller difference in BD removal rates is observed at 0.7 wt-%, indicating that the benefit of using a higher M_{w} PVP grade is most pronounced at a lower PVP concentration. It is desirable to identify the lowest possible (PVP concentration)/(BD removal rate) ratio for cost optimization (i.e., the lowest possible PVP concentration enabling a BD removal rate fulfilling the target for a particular application).

TABLE 2
BD Removal Rate for Polishing Compositions
With Different Concentrations and Mw of PVP

| | PVP | PVP | PVP | PVP | PVP |
|---|---|---|---|---|---|
| PVP grade | K-15 | K-30 | K-60 | K-90 | K-120 |
| (M_{w}, kg/mol) | (10.5) | (60) | (430) | (1,350) | (2,550) |
| PVP Concentration | Black Diamond (BD) removal rates (Å/min) | | | | |
| (wt-%) | | | | | |
| 0.07 | 780 | 506 | 566 | 380 | 355 |
| 0.14 | 448 | 509 | 343 | 276 | 270 |
| 0.7 | 328 | 203 | 209 | 234 | 226 |

Table 2 shows PVP concentrations, weight average molecular weights (M_{w}), and black diamond removal rates for CMP compositions in which the polymeric low-k suppressor is one of PVP K-15, K-30, K-60, K-90, or K-120. Weight average molecular weight (M_{w}) denotes an average of the highest and lowest M_{w} values in the range of the PVP grade. For example, 10.5 kg/mol is the average of the highest and lowest molecular weight values (6 kg/mol and 15 kg/mol, respectively) for PVP K-15.

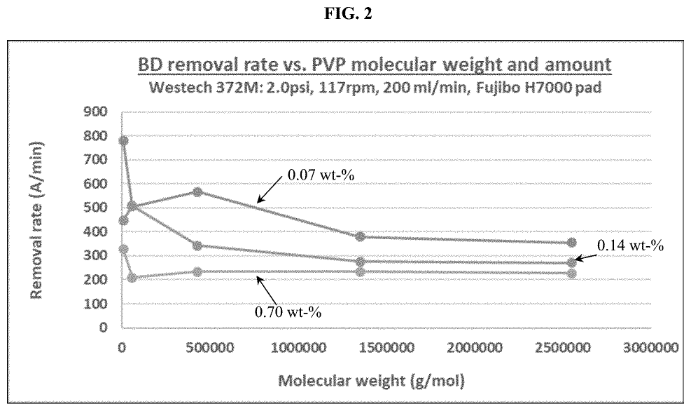

FIG. 2 shows the concentration dependence of the BD removal rate for different grades (weight average molecular weights) of PVP. A higher weight average molecular weight generally enables a lower BD removal rate, but the effect is most pronounced for PVP concentrations ≤0.14 wt-% (e.g., 0.07 wt-%).

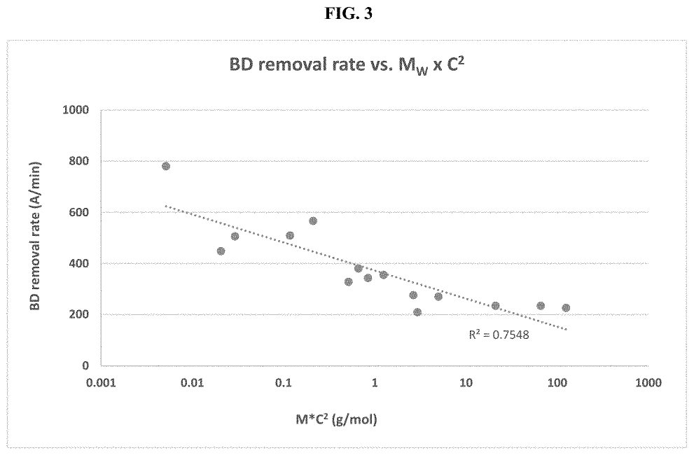

FIG. 3 shows black diamond (BD) removal rates versus M_{w}×C², where M_{w} is PVP weight average molecular weight (kg/mol) and C is PVP concentration (g/kg). A good logarithmic fit is observed between BD removal rates and M_{w}×C², indicating that M_{w}×C²≥2.65 mg/mol enables BD removal rates ≤276 Å/min. Table 3 shows PVP concentrations (g/kg), PVP grades, calculated M_{w}×C², and BD removal rates.

TABLE 3
BD Removal Rate and M_{w} × C² for Different Concentrations and M_{w} of PVP

| | Black diamond removal rate | | | | | | | | | |
|---|---|---|---|---|---|---|---|---|---|---|
| | (Å/min) | | | | | M_{w} × C² (mg/mol) | | | | |
| | PVP grade¹ | | | | | | | | | |
| PVP | K-15 | K-30 | K-60 | K-90 | K-120 | K-15 | K-30 | K-60 | K-90 | K-120 |
| concentration, C | | | | | | | | | | |
| (g/kg) | | | | | | | | | | |
| 0.7 | 780 | 506 | 566 | 380 | 355 | 0.005 | 0.029 | 0.21 | 0.66 | 1.25 |
| 1.4 | 448 | 509 | 343 | 276 | 270 | 0.021 | 0.12 | 0.84 | 2.65 | 5.00 |
| 7 | 328 | 203 | 209 | 234 | 226 | 0.51 | 2.94 | 21.1 | 66.2 | 125.0 |

¹Median molecular weights: K-15 = 10.5 kg/mol; K-30 = 60 kg/mol; K-60 = 430 kg/mol; K-90 = 1,350 kg/mol; and K-120 = 2,550 kg/mol.

Although the present disclosure is not bound by any particular theory, the physical model for M_{w}×C² considers typical logarithmic adsorption isotherms of a polymer on a surface. It has been demonstrated that PVP adsorption isotherms on kaolinite (Al₂Si₂O₅(OH)₄) are dependent on both M_{w} and PVP concentration. (See Hild et al., 123-24 COLLOIDS SURFACES A: PHYSICOCHEM. ENG'G ASPECTS 515-22 (1997).) Although kaolinite is different from BD (SiOC:H), PVP adsorption on kaolinite and on BD may exhibit some general similarities and/or trends.

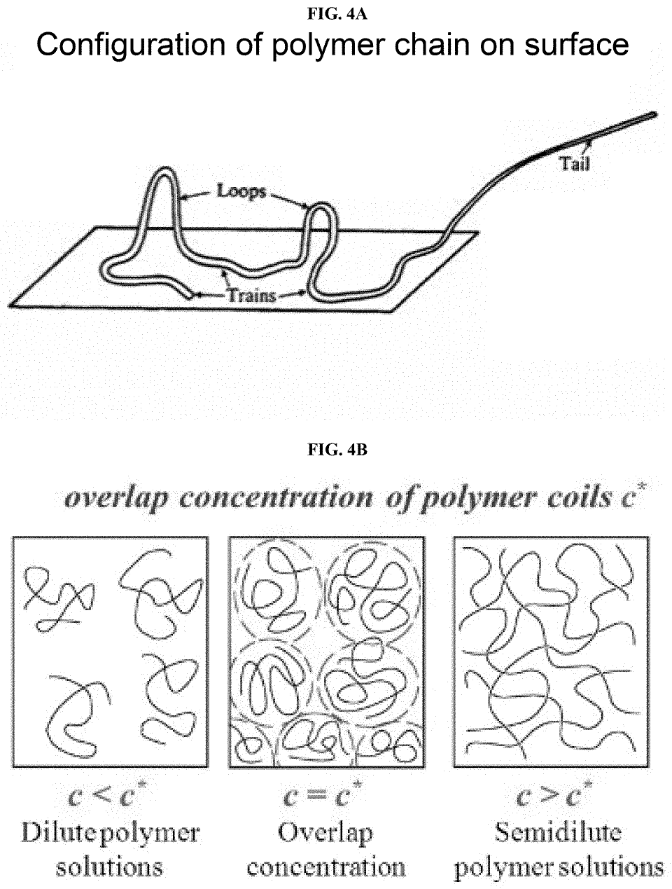

FIG. 4A shows a schematic illustration of the configuration of a polymer chain on a surface. The overlap concentration of polymer coils is shown in FIG. 4B. A polymer chain on a surface can be described by trains, loops and tails (FIG. 4A). The overlap concentration c* describes the concentration above which overlap occurs between polymer coils (FIG. 4B). In a dilute polymer solution, where c<c*, the polymer chain lies flat. The fraction of train segments in the adsorbed layer is very high for dilute polymer solutions. In a semi-dilute polymer solution, where c>c*, a larger fraction of the polymer exists in segments in loops and particularly in extended tails. (See M. A. Cohen Stuart et al., 17 MACROMOLECULES 1825 (1984).)

A greater increase in the PVP hydrodynamic layer thickness (defined as the sum of the time-average of the molecular volume and the volume of the solvent molecules associated with it) is observed for PVP adsorption on kaolinite in the semi-dilute regime. A higher M_{w} enables a semi-dilute regime at a lower PVP concentration, which affects the shape and maximum value of the PVP adsorption isotherm at that M_{w}. Lower weight average molecular weight PVP grades (e.g., K-15) require a higher concentration to fulfill the semi-dilute condition c>c*. On the other hand, above a minimum PVP M_{w} (e.g., ≥44 kg/mol for PVP adsorption on kaolinite), there is not a significant difference in PVP adsorption isotherm curves or maximum PVP adsorption. The combination of concentration-dependent polymer solution regimes and potentially no significant impact of PVP M_{w} for M_{w}≥M_{w,critical} suggests that PVP concentration should have a higher “numerical weight” than PVP M_{w} in a numerical key parameter. Although no experimental evidence is currently available, the unit mg/mol for M_{w}×C² suggests that it may describe milligrams of adsorbed PVP versus each mole of PVP in solution.

While certain embodiments have been illustrated and described, it should be understood that changes and modifications can be made therein in accordance with ordinary skill in the art without departing from the technology in its broader aspects as defined in the following claims. Other embodiments are set forth in the following claims.

1. A chemical mechanical polishing slurry, comprising
an abrasive;
a solvent; and
a polymeric low-k suppressor with M_{w}×C²>0.5 mg/mol, where M_{w} is weight average molecular weight and C is concentration,
wherein the M_{w} is greater than 4 kg/mol and the concentration of polymeric low-k suppressor is ≥0.01 wt-%.

2. The chemical mechanical polishing slurry of claim 1, wherein the polymeric low-k suppressor has a M_{w}×C²>1.5 mg/mol.

3. The chemical mechanical polishing slurry of claim 1, wherein the polymeric low-k suppressor has a M_{w}×C²>2.5 mg/mol.

4. The chemical mechanical polishing slurry of claim 1, wherein the weight average molecular weight of polymeric low-k suppressor is greater than 6 kg/mol.

5. The chemical mechanical polishing slurry of claim 1, wherein the weight average molecular weight of polymeric low-k suppressor is greater than 40 kg/mol.

6. The chemical mechanical polishing slurry of claim 1, wherein the weight average molecular weight of the polymeric low-k suppressor is greater than 250 kg/mol.

7. The chemical mechanical polishing slurry of claim 1, wherein the weight average molecular weight of the polymeric low-k suppressor is greater than 390 kg/mol.

8. The chemical mechanical polishing slurry of claim 1, wherein the weight average molecular weight of polymeric low-k suppressor is equal to or less than 3,000 kg/mol.

9. The chemical mechanical polishing slurry of claim 1, wherein the polymeric low-k suppressor contains one or more carbonyl group(s), and optionally also one or more ethoxylated unit(s).

10. The chemical mechanical polishing slurry of claim 1, wherein the polymeric low-k suppressor is selected from the group consisting of polyvinyl pyrrolidone (PVP), aliphatic polyketones, poly (vinyl methyl ketone), poly (N-hydroxy propyl)methacrylamide, poly (N-vinyl acetamide), polylactic acid, poly(N-butyl methacrylate), poly(N-vinylpyrrolidone/vinyl acetate) and poly(ethylene oxide).

11. The chemical mechanical polishing slurry of claim 1, wherein the slurry has a pH of 9-12.

12. The chemical mechanical polishing slurry of claim 1, wherein the polymeric low-k suppressor in the slurry is capable of selectively suppressing removal of a low-k material.

13. The chemical mechanical polishing slurry of claim 1, wherein the low-k material is selected from the group consisting of SiOC or SiOCH.

14. A method of suppressing removal of a low-k material, comprising polishing a substrate comprising the low-k material, and an additional material with a chemical mechanical polishing slurry of claim 1, wherein the additional material is selectively removed at a higher rate than the low-k material.
